(19) United States
(12) Patent Application Publication
(10) Pub. No.: US 2026/0302326 A1
(43) Pub. Date: Oct. 1, 2026

(54) LITHIUM-ION SECONDARY BATTERY

(71) Applicant: HONDA MOTOR CO., LTD., Tokyo (JP)

(72) Inventors: Takeshi FUJINO, Saitama (JP); Takaharu HIRUMA, Saitama (JP)

(21) Appl. No.: 19/555,904

(22) Filed: Mar. 4, 2026

(30) Foreign Application Priority Data
Mar. 28, 2025 (JP) 2025-056427

(51) Int. Cl. H01M 10/0525; H01M 4/40; H01M 4/525; H01M 10/0567; H01M 10/0568; H01M 10/0569

(52) U.S. Cl. CPC H01M 10/0525; H01M 4/405; H01M 4/525; H01M 10/0567; H01M 10/0568; H01M 10/0569; H01M 2300/0034; H01M 2300/0037

(57) ABSTRACT

Provided is a lithium-ion secondary battery including a positive electrode including a positive electrode mixture layer containing a lithium transition metal composite oxide having a Ni content in a transition metal of 80 mol % or more, a negative electrode including a negative electrode mixture layer containing a lithium alloy, and a localized high concentration electrolyte containing a supporting electrolyte, and an organic solvent, wherein the lithium alloy contains Mg and Sn.

This application is based on and claims the benefit of priority from Japanese Patent Application No. 2025-056427, filed on 28 Mar. 2025, the content of which is incorporated herein by reference.

### BACKGROUND OF THE INVENTION

### Field of the Invention

The present invention relates to a lithium-ion secondary battery.

### Related Art

In recent years, in order to ensure more people access to affordable, reliable, sustainable, and advanced energy, research and development on lithium-ion secondary batteries that contribute to improvement in energy efficiency is being carried out.

Japanese Unexamined Patent Application, Publication No. 2023-71075 describes a nonaqueous electrolyte energy storage element that includes a negative electrode active material layer having a lithium alloy, and a nonaqueous electrolyte containing an ionic liquid. In this case, the lithium alloy contains Mg.
Patent Document 1: Japanese Unexamined Patent Application, Publication No. 2023-71075

### SUMMARY OF THE INVENTION

In general, when charge and discharge are repeated in a lithium-ion secondary battery including a negative electrode active material layer having a lithium alloy, non-uniform dissolution and precipitation reactions of lithium metal occur, the thickness of the negative electrode active material layer increases, the amount of lithium that can contribute to charge and discharge in the negative electrode active material layer, that is, an active lithium amount decreases, and battery performance decreases. Furthermore, as a result of these phenomena piling up, charge and discharge reactions on the electrode surface may become uneven, a micro-short circuit may occur, and the voltage may drop.

On the other hand, when charge and discharge are repeated at a high current density in the nonaqueous electrolyte energy storage element described in Japanese Unexamined Patent Application, Publication No. 2023-71075, the thickness of the negative electrode active material layer increases, and the active lithium amount decreases.

Furthermore, in general, a lithium-ion secondary battery including a negative electrode active material layer having a lithium alloy is required to increase a volumetric energy density, as compared with a lithium-ion secondary battery in which carbon is used as the negative electrode active material. In order to increase the volumetric energy density, for example, it is conceivable to decrease the film thickness of a separator, and increase the thickness of the positive electrode active material layer to increase the packing density of the positive electrode active material per unit area of the positive electrode. However, since the capacity per area of the positive electrode active material layer that faces the negative electrode active material layer increases with respect to the capacity per area of the negative electrode active material layer, the current density during charge and discharge increases, as a result of which, the thickness of the negative electrode active material layer having a lithium alloy tends to increase if charge and discharge are repeated.

Furthermore, when a lithium transition metal composite oxide is used as the positive electrode active material, the larger the Ni content in the transition metal, the more easily the metal in the lithium transition metal composite oxide dissolves into the electrolytic solution, and therefore, the thickness of the negative electrode active material layer having a lithium alloy easily increases. Therefore, it is also conceivable to use a localized high concentration electrolyte, but it is difficult to suppress increase in thickness of the negative electrode active material layer having a lithium alloy with only the localized high concentration electrolyte.

From the above, if charge and discharge are repeated at a high current density in a lithium-ion secondary battery at a high energy density, a capacity retention rate will decrease.

It is an object of the present invention to provide a lithium-ion secondary battery that has a high energy density, and is capable of suppressing increase in thickness of a negative electrode mixture layer containing a lithium alloy, and decrease in an active lithium amount even when charge and discharge are repeated at a high current density.

(1) A lithium-ion secondary battery includes a positive electrode including a positive electrode mixture layer containing a lithium transition metal composite oxide having a Ni content in a transition metal of 80 mol % or more, a negative electrode including a negative electrode mixture layer containing a lithium alloy, and a localized high concentration electrolyte containing a supporting electrolyte, and an organic solvent, in which the lithium alloy contains Mg and Sn.

(2) In the lithium-ion secondary battery as described in (1) above, the lithium alloy is a ternary alloy.

(3) In the lithium-ion secondary battery as described in (1) above, the lithium alloy further contains Bi.

(4) In the lithium-ion secondary battery as described in (3) above, the lithium alloy is a quaternary alloy.

(5) In the lithium-ion secondary battery as described in (3) or (4) above, the lithium alloy has a Bi content of 0.1 mass % or more and 0.3 mass % or less.

(6) In the lithium-ion secondary battery as described in any one of (1) to (5) above, the lithium alloy has a Mg content of 0.4 mass % or more and 4 mass % or less.

(7) In the lithium-ion secondary battery as described in any one of (1) to (6) above, the lithium alloy has a Sn content of 0.9 mass % or more and 11 mass % or less.

(8) In the lithium-ion secondary battery as described in any one of (1) to (7) above, the supporting electrolyte contains lithium bis(fluorosulfonyl)imide.

(9) In the lithium-ion secondary battery as described in (8) above, the localized high concentration electrolyte has a concentration of lithium bis(fluorosulfonyl)imide of 1.0 mol/L or more and 3.0 mol/L or less.

(10) In the lithium-ion secondary battery as described in (8) or (9) above, the organic solvent contains 1,2-dimethoxyethane.

(11) In the lithium-ion secondary battery as described in (10), a molar ratio of 1,2-dimethoxyethane to lithium bis(fluorosulfonyl)imide is 1.7 or more and 2.4 or less.

(12) IN the lithium-ion secondary battery as described in (10) or (11), the organic solvent further contains 1,1,2,2-tetrafluoroethyl-2,2,2-trifluoroethyl ether.

(13) In the lithium-ion secondary battery as described in any one of (8) to (12) above, the localized high concentration electrolyte further contains one or more types of additives selected from a group consisting of a polymer compound having a molecular weight of 2000 or less, lithium difluoro(oxalato)borate, and lithium difluorophosphate (LiDFP).

According to an embodiment of the present invention, it is possible to provide the lithium-ion secondary battery that has a high energy density, and is capable of suppressing increase in the thickness of the negative electrode mixture layer containing a lithium alloy, and decrease in active lithium amount even when charge and discharge are repeated at a high current density.

### DETAILED DESCRIPTION OF THE INVENTION

Hereinafter, an embodiment of the present invention will be described.

A lithium-ion secondary battery of the present embodiment includes a positive electrode including a positive electrode mixture layer containing a lithium transition metal composite oxide having a Ni content in a transition metal of 80 mol % or more, a negative electrode including a negative electrode mixture layer containing a lithium alloy, and a localized high concentration electrolyte containing a supporting electrolyte, and an organic solvent. Here, the lithium alloy contains Mg and Sn. Consequently, the energy density increases, and even when charge and discharge are repeated at a high current density, increase in thickness of the negative electrode mixture layer containing a lithium alloy and decrease in an active lithium amount are suppressed. At this time, a volumetric energy density of the lithium-ion secondary battery of the present embodiment is, for example, 900 Wh/L or more. Furthermore, a capacity per unit area of the positive electrode is, for example, 4 mAh/cm² or more.

In the present description and claims, the localized high concentration electrolyte means an electrolytic solution that is reduced in viscosity while maintaining a stable solvation structure, obtained by diluting a highly concentrated electrolytic solution with a non-polar solvent (for example, an ether solvent).

The lithium alloy may further contain Bi. Specific examples of the lithium alloy include an Li—Mg—Sn alloy (ternary alloy), and Li—Mg—Sn—Bi alloy (quaternary alloy).

A Mg content in the lithium alloy is preferably 0.4 masso or more and 4 mass % or less, and is more preferably 0.5 masso or more and 3 mass % or less. When the Mg content in the lithium alloy is 0.4 mass % or more and 4 mass % or less, increase in the thickness of the negative electrode is suppressed, and decrease in the active lithium amount in the lithium alloy of the negative electrode is suppressed, even when charge and discharge are repeated at a high current density.

A Sn content in the lithium alloy is preferably 0.9 mass % or more and 11 mass % or less, and more preferably 1 mass or more and 6 mass % or less. When the Sn content in the lithium alloy is 0.9 mass % or more and 11 mass % or less, increase in the thickness of the negative electrode mixture layer containing a lithium alloy is suppressed, and as a result, a micro-short circuit is also suppressed, even when charge and discharge are repeated at a high current density.

A Bi content in the lithium alloy is preferably 0.1 mass % or more and 0.3 mass % or less, and is more preferably 0.15 mass % or more and 0.25 mass % or less. When the Bi content in the lithium alloy is 0.1 mass % or more and 0.3 mass % or less, increase in the thickness of the negative electrode mixture layer containing the lithium alloy and decrease in the active lithium amount are suppressed, even when charge and discharge are repeated at a high current density.

The negative electrode has, for example, a lithium alloy layer formed on a negative electrode current collector. A thickness of the lithium alloy layer is not particularly limited, but is, for example, 1 μm or more and 100 μm or less.

The material that forms the negative electrode current collector is not particularly limited, but examples thereof include silver, palladium, gold, platinum, aluminum, copper, nickel, stainless steel, and carbon. Among them, from the viewpoint of conductivity and cost, copper, stainless steel, and nickel are preferable.

The shape of the negative electrode current collector is not particularly limited, but examples thereof include a foil shape, a plate shape, a mesh shape, a nonwoven fabric form, and a foamlike form.

The thickness of the negative electrode current collector is not particularly limited, but is, for example, 5 μm or more and 20 μm or less.

A supporting electrolyte contained in the localized high concentration electrolyte is not particularly limited as long as it is a lithium salt, but examples thereof include lithium bis(fluorosulfonyl)imide, lithium (fluorosulfonyl) (trifluoromethylsulfonyl)imide, lithium (fluorosulfonyl) (pentafluoroethylsulfonyl)imide, lithium hexafluorophosphate, and lithium tetrafluoroborate, and two or more types may be used in combination. Among them, lithium bis(fluorosulfonyl)imide is preferable because increase in the thickness of the negative electrode mixture layer containing a lithium alloy is suppressed even when charge and discharge are repeated at a high current density.

The concentration of the lithium bis(fluorosulfonyl)imide in the localized high concentration electrolyte is preferably 1.0 mol/L or more and 3.0 mol/L or less, and more preferably 1.2 mol/L or more and 2.5 mol/L or less. When the concentration of the lithium bis(fluorosulfonyl)imide in the electrolytic solution is 1.0 mol/L or more and 3.0 mol/L or less, increase in the thickness of the negative electrode mixture layer containing a lithium alloy is suppressed even when charge and discharge are repeated at a high C rate.

The organic solvent contained in the localized high concentration electrolyte is not particularly limited as long as it can dissolve the supporting electrolyte, but examples thereof include 1,2-dimethoxyethane, 1,2-diethoxyethane, ethoxymethoxyethane, diethyl ether, 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, ethylene carbonate, propylene carbonate, vinylene carbonate, fluoroethylene carbonate, dimethyl carbonate, diethyl carbonate, ethyl methyl carbonate, tetrahydrofuran, 2-methyl tetrahydrofuran, tetrahydropyran, 1,3-dioxolane, 4-methyl 1,3-dioxolane, 1,2-bis(1,1,2,2-tetrafluoroethoxy) ethane, anisole, sulfolane, methyl sulfolane, γ-butyrolactone, acetate ester, butyrate ester, propionate ester, acetonitrile, and propionitrile, and two or more types may be used in combination. Among them, chain ether is preferable, and 1,2-dimethoxyethane, and 1,2-diethoxyethane are more preferable, because they react little with the negative electrode mixture layer containing a lithium alloy, and are less likely to decompose even after charge and discharge are repeated at a high current density. Furthermore, to make the localized high concentration electrolyte, it is more preferable to use 1,1,2,2-tetrafluoroethyl-2,2,2-trifluoroethyl ether in combination. In the case of using 1,2-dimethoxyethane, and 1,1,2,2-tetrafluoroethyl-2,2,2-trifluoroethyl ether in combination, a molar ratio of 1,1,2,2-tetrafluoroethyl-2,2,2-trifluoroethyl ether to 1,2-dimethoxyethane is, for example, 0.7 or more and 1.3 or less.

A molar ratio of 1,2-dimethoxyethane to lithium bis(fluorosulfonyl)imide is preferably 1.7 or more and 2.4 or less, and is more preferably 1.8 or more and 2.3 or less. When the molar ratio of 1,2-dimethoxyethane to lithium bis(fluorosulfonyl)imide is 1.7 or more and 2.4 or less, increase in the thickness of the negative electrode mixture layer that contains a lithium alloy is suppressed even after charge and discharge are repeated at a high current density. Furthermore, when the molar ratio of 1,2-dimethoxyethane to lithium bis(fluorosulfonyl)imide is 1.8 or more and 2.3 or less, generation of gas due to oxidative decomposition of the organic solvent is suppressed even after charge and discharge are repeated at a high current density.

The localized high concentration electrolyte preferably further contains one or more types of additives selected from a group consisting of a polymer compound having a molecular weight of 2000 or less, lithium difluoro(oxalato)borate, and lithium difluorophosphate (LiDFP). This suppresses increase in the thickness of the negative electrode mixture layer that contains a lithium alloy and generation of gas due to oxidative decomposition of the organic solvent, even after charge and discharge are repeated at a high current density. The polymer compound having a molecular weight of 2000 or less is not particularly limited as long as it can be dissolved into the localized high concentration electrolyte, but examples thereof include polyethylene glycol in which terminals may be modified.

In the lithium-ion secondary battery of the present embodiment, a separator is preferably disposed between a positive electrode and a negative electrode. The separator has, for example, a substrate, and an insulating layer formed on at least one surface of the substrate. In this case, the insulating layer of the separator is disposed so as to face the positive electrode mixture layer, for example.

The substrate is not particularly limited as long as it can be impregnated with an electrolytic solution, but examples thereof include woven fabric, nonwoven fabric, and a porous resin film. The material that forms the substrate is not particularly limited, but examples thereof include polyolefins such as polyethylene, and polypropylene.

The insulating layer preferably contains organic particles or inorganic particles, and may further contain a binder or the like. The materials that form the organic particles are not particularly limited, but examples thereof include polyvinylidene fluoride (PVDF), polyethylene glycol (PEG), and polymethyl methacrylate (PMMA). Furthermore, the materials that form inorganic particles are not particularly limited, but examples thereof include carbons such as carbon black, graphite, and carbon nanotubes, oxides such as iron oxide, silicon oxide, aluminum oxide, titanium oxide, zirconium oxide, calcium oxide, strontium oxide, barium oxide, and magnesium oxide, and nitrides such as aluminum nitride, and silicon nitride. Among them, aluminum oxide is preferable.

The positive electrode has, for example, the positive electrode mixture layer formed on a positive electrode current collector.

The lithium transition metal composite oxide contained in the positive electrode mixture layer is not particularly limited as long as a Ni content in the transition metal is 80 mol % or more, but examples thereof include lithium nickel oxide (LiNiO₂), LiNiₚMn_{g}CoᵣO₂ (p+q+r=1), LiNiₚAl_{q}CoᵣO₂ (p+q+r=1), Li₁₊ₓMn_{2-x-y}M_{y}O₄ (x+y=2) (where M is one or more types of elements selected from a group consisting of Al, Mg, Co, Fe, Ni, and Zn), and LiMPO₄ (where M is one or more types of elements selected from a group consisting of Fe, Mn, Co, and Ni). The lithium transition metal composite oxide content in the positive electrode mixture layer is not particularly limited, but is, for example, 80 mass % or more and 99 mass % or less.

The lithium transition metal composite oxide may have a coating layer that contains an oxide or sulfide formed on a surface. Examples of the oxide include an aluminum oxide, zirconium oxide, tungsten oxide, niobium oxide, and lithium borate. Furthermore, examples of the sulfide include a lithium sulfate.

The positive electrode mixture layer may further contain a solid electrolyte. The solid electrolyte is not particularly limited as long as it can conduct lithium ions, but examples thereof include oxide solid electrolytes.

The positive electrode mixture layer may further contain a binder, a conductive additive, and the like.

A method for forming the positive electrode mixture layer is not particularly limited, but examples thereof include a method of coating a slurry containing a positive electrode active material, and a solvent.

The material that forms the positive electrode current collector is not particularly limited, but examples thereof include an aluminum, aluminum alloy, stainless steel, nickel, iron, and titanium. Among them, an aluminum, aluminum alloy, and stainless steel are preferable.

A shape of the positive electrode current collector is not particularly limited, but examples thereof include a foil shape, and a plate shape.

The embodiment of the present invention is described above, but the present invention is not limited to the above-described embodiment, and the above-described embodiment may be appropriately changed within the range of the gist of the present invention.

### EXAMPLES

Hereinafter, examples of the present invention are described, but the present invention is not limited to the examples.

### [Fabrication of Positive Electrode]

By using a rotation and revolution mixer, 2 parts by mass of acetylene black (AB), 1.5 parts by mass of polyvinylidene fluoride (PVDF), and polyvinylpyrrolidone (PVP), were premixed with N-methyl-2-pyrrolidone (NMP), and premixed slurry was obtained. Next, by using a planetary mixer, LiNi_{0.8}Co_{0.1}Mn_{0.1}O₂ (NCM811), and the premixed slurry were mixed, and paste for positive electrode mixture layer was obtained. Next, aluminum foil was coated with the paste for positive electrode mixture layer and dried, after which, the aluminum foil was pressed by a roll press, and a positive electrode mixture layer having a thickness of 64 μm, and a density of 3.3 g/cm³ was formed. Next, after it was dried in a vacuum at 120° C., and a positive electrode plate was obtained, the positive electrode plate was punched out to a size of 30 mm×40 mm, and a positive electrode was obtained. Here, in NCM811 as the lithium transition metal composite oxide, a molar ratio of nickel, cobalt, and manganese is 84:8:8, and a median diameter (D₅₀) is 4 μm. Furthermore, the positive electrode had a capacity per unit mass of 205 to 210 mAh/g.

### [Separator]

A separator (commercially available) was used, in which an insulating layer having a thickness of 2 μm and containing alumina particles was formed on a surface on one side of a polyethylene microporous film having a thickness of 9 μm.

### Example 1

### (Fabrication of Negative Electrode)

A clad material of a copper foil having a thickness of 10 μm, and a lithium alloy foil having a thickness of 20 μm was punched out to a size of 34 mm×44 mm, and a negative electrode including a lithium alloy layer was obtained. Here, the lithium alloy forming a lithium alloy foil is a ternary alloy that has a Mg content of 3 mass %, and a Sn content of 3 mass %.

### (Fabrication of Localized High Concentration Electrolyte)

After 20 mol % of lithium bis(fluorosulfonyl)imide (LiFSI), 46 mol % of 1,2-dimethoxyethane (DME), and 34 mol % of 1,1,2,2-tetrafluoroethyl-2,2,2-trifluoroethyl ether (TTE) were mixed, lithium difluoro(oxalato)borate (LiFOB) and lithium difluorophosphate (LiDFP) were added, and a localized high concentration electrolyte was obtained. At this time, in the localized high concentration electrolyte, a concentration of LiFSI was 2.0 mol/L, a molar ratio of DME to LiFSI was 2.3, the LiFOB content was 0.5 mass %, and the LiDFP content was 0.2 mass %.

### (Fabrication of Lithium-ion Secondary Battery)

After the positive electrode, the separator, and the negative electrode were introduced into a container made of heat-sealing aluminum laminate for secondary batteries (manufactured by Dai Nippon Printing Co., Ltd.) and processing it into a bag shape, 350 μL of the localized high concentration electrolyte was poured, and the container was left at 45° C. for 5 hours. At this time, the insulating layer of the separator was disposed so as to face the positive electrode mixture layer. Next, charge and discharge (4.3 V to 2.65 V) were carried out twice at 25° C., and 0.1 C, and a lithium-ion secondary battery was obtained. The energy density per volume of the stacked body of the electrodes and the separator of the lithium-ion secondary battery was 1150 Wh/L.

### Example 2

### (Preparation of Localized High Concentration Electrolyte)

A localized high concentration electrolyte was obtained in the same manner as in Example 1, except that 40 mol % of 1,2-dimethoxyethane (DME) and 40 mol % of 1,1,2,2-tetrafluoroethyl-2,2,2-trifluoroethyl ether (TTE) were used. At this time, in the localized high concentration electrolyte, the concentration of LiFSI was 2.0 mol/L, the molar ratio of DME to LiFSI was 2.0, the LiFOB content was 0.5 mass %, and the LiDFP content was 0.2 mass %.

### (Fabrication of Lithium-ion Secondary Battery)

A lithium-ion secondary battery was obtained in the same manner as in Example 1, except that the obtained localized high concentration electrolyte was used.

### Example 3

### (Fabrication of Negative Electrode)

A negative electrode was obtained in the same manner as in Example 1, except that the lithium alloy forming the lithium alloy foil was a ternary alloy that has the Mg content of 3 mass %, and the Sn content of 5 mass.

### (Fabrication of Lithium-ion Secondary Battery)

The lithium-ion secondary battery was obtained in the same manner as in Example 2, except that the obtained negative electrode was used.

### Example 4

### (Preparation of Localized High Concentration Electrolyte)

A localized high concentration electrolyte was obtained in the same manner as in Example 3, except that polyethylene glycol (PEG) in which the average molecular weight was 1000, and the terminals were modified was used instead of LiFOB and LiDFP. At this time, in the localized high concentration electrolyte, the concentration of LiFSI was 2.0 mol/L, the molar ratio of DME to LiFSI was 2.0, and the PEG content was 0.1 mass %.

### (Fabrication of Lithium-ion Secondary Battery)

A lithium-ion secondary battery was obtained in the same manner as in Example 3, except that the obtained localized high concentration electrolyte was used.

### Example 5

### (Preparation of Localized High Concentration Electrolyte)

A localized high concentration electrolyte was obtained in the same manner as in Example 1, except that 36 mol % of 1,2-dimethoxyethane (DME), and 44 mol % of 1,1,2,2-tetrafluoroethyl-2,2,2-trifluoroethyl ether (TTE) were used, and LiDFP was not added. At this time, in the localized high concentration electrolyte, the concentration of LiFSI was 2.0 mol/L, the molar ratio of DME to LiFSI was 1.8, and the LiFOB content was 0.5 mass %.

### (Fabrication of Lithium-ion Secondary Battery)

A lithium-ion secondary battery was obtained in the same manner as in Example 3, except that the obtained localized high concentration electrolyte was used.

### Example 6

### (Fabrication of Negative Electrode)

A negative electrode was obtained in the same manner as in Example 1, except that the lithium alloy forming the lithium alloy foil was a ternary alloy in which the Mg content was 3 mass %, and the Sn content was 10 mass.

### (Fabrication of Lithium-ion Secondary Battery)

A lithium-ion secondary battery was obtained in the same manner as in Example 2, except that the obtained negative electrode was used.

### Example 7

### (Fabrication of Negative Electrode)

A negative electrode was obtained in the same manner as in Example 1, except that the lithium alloy forming the lithium alloy foil was a quaternary alloy in which the Mg content was 3 mass %, the Sn content was 1 mass %, and the Bi content was 0.2 mass %.

### (Fabrication of Lithium-ion Secondary Battery)

A lithium-ion secondary battery was obtained in the same manner as in Example 2, except that the obtained negative electrode was used.

### Example 8

### (Fabrication of Negative Electrode)

A negative electrode was obtained in the same manner as in Example 1, except that the lithium alloy forming the lithium alloy foil was a quaternary alloy in which the Mg content was 3 mass %, the Sn content was 3 mass %, and the Bi content was 0.2 mass %.

### (Fabrication of Lithium-ion Secondary Battery)

A lithium-ion secondary battery was obtained in the same manner as in Example 2, except that the obtained negative electrode was used.

### Example 9

### (Fabrication of Negative Electrode)

A negative electrode was obtained in the same manner as in Example 1, except that the lithium alloy forming the lithium alloy foil was a quaternary alloy in which the Mg content was 3 mass %, the Sn content was 5 mass %, and the Bi content was 0.2 mass %.

### (Fabrication of Lithium-ion Secondary Battery)

A lithium-ion secondary battery was obtained in the same manner as in Example 2, except that the obtained negative electrode was used.

### Example 10

### (Fabrication of Negative Electrode)

A negative electrode was obtained in the same manner as in Example 1, except that the lithium alloy forming the lithium alloy foil was a quaternary alloy in which the Mg content was 0.5 mass %, the Sn content was 1 mass %, and the Bi content was 0.2 mass %.

### (Fabrication of Lithium-ion Secondary Battery)

A lithium-ion secondary battery was obtained in the same manner as in Example 2, except that the obtained negative electrode was used.

### Comparative Example 1

### (Fabrication of Negative Electrode)

A negative electrode that includes a lithium metal layer was obtained in the same manner as in Example 1, except that a clad material of a copper foil having a thickness of 10 μm and a lithium foil having a thickness of 20 μm was used instead of the clad material of the copper foil having a thickness of 10 μm and the lithium alloy foil having a thickness of 20 μm.

### (Preparation of Localized High Concentration Electrolyte)

A localized high concentration electrolyte was obtained in the same manner as in Example 1, except that 50 mol % of 1,2-dimethoxyethane (DME), and 30 mol % of 1,1,2,2-tetrafluoroethyl-2,2,2-trifluoroethyl ether (TTE) were used. At this time, in the localized high concentration electrolyte, the concentration of LiFSI was 2.0 mol/L, the molar ratio of DME to LiFSI was 2.5, the LiFOB content was 0.5 mass %, and the LiDFP content was 0.2 mass %.

### (Fabrication of Lithium-ion Secondary Battery)

A lithium-ion secondary battery was obtained in the same manner as in Example 1, except that the obtained negative electrode and localized high concentration electrolyte were used.

### Comparative Example 2

### (Fabrication of Negative Electrode)

A negative electrode was obtained in the same manner as in Example 1, except that the lithium alloy forming the lithium alloy foil was a secondary alloy that had a Mg content of 1 mass %.

### (Fabrication of Lithium-ion Secondary Battery)

A lithium-ion secondary battery was obtained in the same manner as in Comparative Example 1, except that the obtained negative electrode was used.

### Comparative Example 3

### (Fabrication of Negative Electrode)

A negative electrode was obtained in the same manner as in Example 1, except that the lithium alloy forming the lithium alloy foil was a secondary alloy that had the Mg content of 3 mass %.

### (Fabrication of Lithium-ion Secondary Battery)

A lithium-ion secondary battery was obtained in the same manner as in Comparative Example 1, except that the obtained negative electrode was used.

### Comparative Example 4

### (Fabrication of Negative Electrode)

The negative electrode was obtained in the same manner as in Example 1, except that the lithium alloy forming the lithium alloy foil was a secondary alloy that had the Mg content of 5 masse.

### (Fabrication of Lithium-ion Secondary Battery)

A lithium-ion secondary battery was obtained in the same manner as in Comparative Example 1, except that the obtained negative electrode was used.

### Comparative Example 5

### (Fabrication of Negative Electrode)

The negative electrode was obtained in the same manner as in Example 1, except that the lithium alloy forming the lithium alloy foil was a secondary alloy that had the Sn content of 1 mass %.

### (Fabrication of Lithium-ion Secondary Battery)

A lithium-ion secondary battery was obtained in the same manner as in Comparative Example 1, except that the obtained negative electrode was used.

### Comparative Example 6

### (Fabrication of Negative Electrode)

The negative electrode was obtained in the same manner as in Example 1, except that the lithium alloy forming the lithium alloy foil was a secondary alloy that had the Sn content of 3 mass.

### (Fabrication of Lithium-ion Secondary Battery)

The lithium-ion secondary battery was obtained in the same manner as in Comparative Example 1, except that the obtained negative electrode was used.

### Comparative Example 7

### (Fabrication of Negative Electrode)

A negative electrode was obtained in the same manner as in Example 1, except that the lithium alloy forming the lithium alloy foil was a secondary alloy that had the Sn content of 5 mass %.

### (Fabrication of Lithium-ion Secondary Battery)

A lithium-ion secondary battery was obtained in the same manner as in Comparative Example 1, except that the obtained negative electrode was used.

### (Resistance Per Unit Area of Positive Electrode)

Resistance per unit area of the positive electrodes of the lithium-ion secondary batteries was measured. Specifically, constant current charge was carried out at 25° C., and 4.5 C up to 50% of an initial discharge capacity of the lithium-ion secondary battery, and after the SOC reached 50%, discharge was carried out at 4.5 C for 10 seconds, and the resistance was calculated. Next, the resistance was divided by the area (12 cm²) of the positive electrode, and the resistance [Ω.cm²] per unit area of the positive electrode was calculated.

### [Capacity Retention Rate]

Capacity retention rates of the lithium-ion secondary batteries were evaluated. Specifically, constant current constant voltage charge was carried out up to 4.3 V at 25° C., and 1/3 C first, after which, constant voltage charge was carried out for 20 minutes, and the lithium-ion secondary battery was left for 10 minutes. Next, constant current discharge was carried out to 2.65 V at 25° C., and 1/3 C, and the initial discharge capacity was measured.

Charge and discharge (4.3 V to 2.65 V) were carried out 49 times in the same manner as described above, and thereafter, the lithium-ion secondary battery was left for six hours. Next, charge and discharge (4.3 V to 2.65 V) were carried out in the same manner as described above, and the discharge capacity was measured. Next, by the formula:

$$( discharge capacity ) / ( initial discharge capacity ) \times 100 ,$$

$$the capacity retention rate was calculated .$$

### [Thickness of Lithium Alloy (Lithium Metal) Layer]

After constant current charge of the lithium-ion secondary battery the capacity retention rate of which was evaluated was carried out up to 4.25 V (SOC97%) at 25° C., and 1/3 C, the lithium-ion secondary battery was decomposed, and the negative electrode was taken out. Next, by using a contact-type film thickness gauge, the thickness of the lithium alloy (lithium metal) layer was measured.

### [Active Lithium Amount of Lithium Alloy (Lithium Metal) Layer]

The negative electrode the thickness of the lithium alloy (lithium metal) layer of which was measured was punched out to a size of a diameter of 10 mm, and a negative electrode for coin cell was obtained. Next, after a separator having a diameter of 19.4 mm, a gasket, the negative electrode for coin cell, a spacer made of stainless steel, and a washer made of stainless steel were disposed on the copper foil having a diameter of 10 mm, 150 μL of electrolytic solution was poured, and a coin cell was obtained. At this time, the electrolytic solution was poured in two separate steps before and after the separator was disposed. Here, the separator and the electrolytic solution are the same as those of the lithium-ion secondary battery.

After the coin cell was connected to a charge/discharge device so that the side of the lithium alloy layer (or the lithium metal layer) was a negative electrode, and the side of the copper foil was the positive electrode, constant current discharge was carried out to −0.8 V (SOC0%) with a current per unit area of the electrode of 0.21 mA/cm² at 25° C., and the discharge capacity was measured. Next, based on the discharge capacity, the active lithium amount in the lithium alloy (lithium metal) layer was calculated.

Table 1 shows the evaluation result of the lithium-ion secondary batteries.

TABLE 1

| | | | | Electrolytic solution | | |
|---|---|---|---|---|---|---|
| | Li alloy (metal) layer | | | | DME/ | |
| | Mg | Sn | Bi | LiFSI | LiFSI | LiFOB |
| | [mass % ] | [mass % ] | [mass % ] | [mol/L] | (molar ratio) | [mass % ] |
| Example1 | 3 | 3 | — | 2 | 2.3 | 0.5 |
| Example2 | 3 | 3 | — | 2 | 2 | 0.5 |
| Example3 | 3 | 5 | — | 2 | 2 | 0.5 |
| Example4 | 3 | 5 | — | 2 | 2 | — |
| Example5 | 3 | 5 | — | 2 | 1.8 | 0.5 |
| Example6 | 3 | 10 | — | 2 | 2 | 0.5 |
| Example7 | 3 | 1 | 0.2 | 2 | 2 | 0.5 |
| Example8 | 3 | 3 | 0.2 | 2 | 2 | 0.5 |
| Example9 | 3 | 5 | 0.2 | 2 | 2 | 0.5 |
| Example10 | 0.5 | 1 | 0.2 | 2 | 2 | 0.5 |
| Comparative | — | — | — | 2 | 2.5 | 0.5 |
| Example1 | | | | | | |
| Comparative | 1 | — | — | 2 | 2.5 | 0.5 |
| Example2 | | | | | | |
| Comparative | 3 | — | — | 2 | 2.5 | 0.5 |
| Example3 | | | | | | |
| Comparative | 5 | — | — | 2 | 2.5 | 0.5 |
| Example4 | | | | | | |
| Comparative | 0 | 1 | — | 2 | 2.5 | 0.5 |
| Example5 | | | | | | |
| Comparative | 0 | 3 | — | 2 | 2.5 | 0.5 |
| Example6 | | | | | | |
| Comparative | 0 | 5 | — | 2 | 2.5 | 0.5 |
| Example7 | | | | | | |
| | | | Resistance | | Li alloy (metal) | |
| | | | per unit | | layer | |
| | | | area of | | | Active |
| | Electrolytic solution | | positive | Capacity | positive | Li |
| | LiDFP | PEG | electrode | retention | Thickness | amount |
| | [mass % ] | [mass % ] | [Ω · cm² ] | rate [%] | [ μm ] | [%] |
| Example1 | 0.2 | — | 18.5 | 97.2 | 57 | 54.0 |
| Example2 | 0.2 | — | 19.0 | 97.5 | 55 | 54.0 |
| Example3 | 0.2 | — | 19.0 | 98.2 | 50 | 58.5 |
| Example4 | — | 0.1 | 19.0 | 98.0 | 50 | 59.7 |
| Example5 | — | — | 18.0 | 98.0 | 51 | 59.7 |
| Example6 | 0.2 | — | 18.0 | 98.0 | 55 | 60.3 |
| Example7 | 0.2 | — | 18.0 | 97.0 | 57 | 58.5 |
| Example8 | 0.2 | — | 17.6 | 98.4 | 55 | 60.3 |
| Example9 | 0.2 | — | 17.6 | 98.4 | 50 | 61.5 |
| Example10 | 0.2 | — | 18.0 | 97.0 | 57 | 52.7 |
| Comparative | 0.2 | — | 18.5 | 90.5 | 65 | 43.0 |
| Example1 | | | | | | |
| Comparative | 0.2 | — | 18.5 | 92.0 | 65 | 47.3 |
| Example2 | | | | | | |
| Comparative | 0.2 | — | 18.0 | 93.0 | 64 | 47.3 |
| Example3 | | | | | | |
| Comparative | 0.2 | — | 18.0 | 93.0 | 59 | 54.4 |
| Example4 | | | | | | |
| Comparative | 0.2 | — | 18.5 | 95.0 | 65 | 45.0 |
| Example5 | | | | | | |
| Comparative | 0.2 | — | 18.5 | 95.5 | 64 | 45.0 |
| Example6 | | | | | | |
| Comparative | 0.2 | — | 18.0 | 96.0 | 62 | 49.5 |
| Example7 | | | | | | |

From Table 1, it is found that the lithium-ion secondary batteries of Examples 1 to 10 have high energy densities, in which increase in the thickness of the Li alloy layers and decrease in the active Li amounts are suppressed even when charge and discharge are repeated at high current densities, and as a result, the capacity retention rates become high. In contrast, since the lithium-ion secondary batteries of Comparative Examples 1 to 7 include the Li metal layer, the Li—Mg alloy layer, or the Li—Sn alloy layer, the thickness of the Li alloy (metal) layer increases, and the active Li amount in the Li alloy (metal) layer decreases, when charge and discharge are repeated at high current densities.

Here, although the lithium-ion secondary batteries of Comparative Examples 2, 3, 5, and 6 include the Li—Mg alloy layer or the Li—Sn alloy layer, they have comparable increases in the thickness of the Li—Mg alloy layer, and a remarkable improvement for decrease in the active Li amount was not found, when charge and discharge were repeated at high current densities, in contrast to the lithium-ion secondary battery of Comparative Example 1 that includes the Li metal layer that is unalloyed. Although the lithium-ion secondary battery of Comparative Examples 5 and 6 include the Li—Sn alloy layers, the active Li amounts are decreased though the capacity retention rates are slightly improved, when charge and discharge are repeated at high current densities, in contrast to the lithium-ion secondary batteries of Comparative Examples 2 and 3 that include the Li—Mg alloy layers. Furthermore, in the lithium-ion secondary batteries of Comparative Example 4 in which the Mg content in the Li—Mg alloy is 5 mass %, and Comparative Example 7 in which the Sn content in the Li—Sn alloy is 5 mass %, remarkable improvements for increase in thickness of the lithium alloy layer, and decrease in the active Li amount were not found when charge and discharge were repeated at high current densities, in contrast to the lithium-ion secondary battery of Comparative Example 1. This is presumably because the Li—Mg alloy and Li—Sn alloy are instable as the lithium alloys, and Mg ions or Sn ions are dissolved in the electrolytic solution.

On the other hand, since the lithium-ion secondary batteries of Examples 1 to 10 include the Li—Mg—Sn alloy layers or the Li—Mg—Sn—Bi alloy layers, the capacity retention rates are high, and increase in the thickness of the lithium alloy layer, and decrease in the active Li amount are small when charge and discharge are repeated at high current densities, in contrast to the lithium-ion secondary batteries of Comparative Examples 1 to 7. In particular, in the lithium-ion secondary batteries of Examples 7 and 10 in which the contents of the metals other than Li in the Li—Mg—Sn—Bi alloys are 4.2 mass % and 1.7 mass %, increase in thickness of the lithium alloy layers and decrease in the active Li amounts are small when charge and discharge are repeated at a high C rate although the contents of the metals other than Li in the lithium alloys are low, in contrast to the lithium-ion secondary batteries of Comparative Examples 4 and 7. This is presumably because the Li—Mg—Sn alloy and the Li—Mg—Sn—Bi alloy are stable as the lithium alloys, and dissolution of Mg ions and Sn ions into the electrolytic solutions is suppressed.

What is claimed is:

1. A lithium-ion secondary battery, comprising:
a positive electrode comprising a positive electrode mixture layer containing a lithium transition metal composite oxide having a Ni content in a transition metal of 80 mol % or more;
a negative electrode comprising a negative electrode mixture layer containing a lithium alloy; and
a localized high concentration electrolyte containing a supporting electrolyte, and an organic solvent, wherein
the lithium alloy contains Mg and Sn.

2. The lithium-ion secondary battery according to claim 1, wherein the lithium alloy is a ternary alloy.

3. The lithium-ion secondary battery according to claim 1, wherein the lithium alloy further contains Bi.

4. The lithium-ion secondary battery according to claim 3, wherein the lithium alloy is a quaternary alloy.

5. The lithium-ion secondary battery according to claim 3, wherein the lithium alloy has a Bi content of 0.1 mass % or more and 0.3 mass % or less.

6. The lithium-ion secondary battery according to claim 1, wherein the lithium alloy has a Mg content of 0.4 mass % or more and 4 mass % or less.

7. The lithium-ion secondary battery according to claim 1, wherein the lithium alloy has a Sn content of 0.9 mass % or more and 11 mass % or less.

8. The lithium-ion secondary battery according to claim 1, wherein the supporting electrolyte contains lithium bis(fluorosulfonyl)imide.

9. The lithium-ion secondary battery according to claim 8, wherein the localized high concentration electrolyte has a concentration of lithium bis(fluorosulfonyl)imide of 1.0 mol/L or more and 3.0 mol/L or less.

10. The lithium-ion secondary battery according to claim 8, wherein the organic solvent contains 1,2-dimethoxyethane.

11. The lithium-ion secondary battery according to claim 10, wherein a molar ratio of 1,2-dimethoxyethane to lithium bis(fluorosulfonyl)imide is 1.7 or more and 2.4 or less.

12. The lithium-ion secondary battery according to claim 10, wherein the organic solvent further contains 1,1,2,2-tetrafluoroethyl-2,2,2-trifluoroethyl ether.

13. The lithium-ion secondary battery according to claim 8, wherein the localized high concentration electrolyte further contains one or more types of additives selected from a group consisting of a polymer compound having a molecular weight of 2000 or less, lithium difluoro(oxalato)borate, and lithium difluorophosphate (LiDFP).
